(19) United States
(12) Patent Application Publication
(10) Pub. No.: US 2026/0087585 A1
(43) Pub. Date: Mar. 26, 2026

(54) INTERMEDIATE FORMATS FOR IMAGE PROCESSING PIPELINES

(71) Applicant: Advanced Micro Devices, Inc., Santa Clara, CA (US)

(72) Inventors: Fabian R. S. Wildgrube, Munich (DE); Matthäus G. Chajdas, Neutraubling (DE); Dominik Jörg Baumeister, Munich (DE)

(73) Assignee: Advanced Micro Devices, Inc., Santa Clara, CA (US)

(21) Appl. No.: 18/898,255

(22) Filed: Sep. 26, 2024

(51) Int. Cl. G06T 1/60

(52) U.S. Cl. CPC G06T 1/60

(57) ABSTRACT

Image processing pipelines are implemented as a series of stages, where each stage receives as its input output from a previous stage (or input to the entire pipeline). Inefficiencies can exist in such pipelines, related to the way in which the stages utilize resources. For example, a simple way of assigning memory or registers to such stages is to simply assign independent sets of memory or registers to each stage. This can be inefficient in the event that data is reused between stages. To alleviate these issues, an entity such as a compiler analyzes the operations to run at each stage and extracts commonly used resources to be reused between stages. In addition, stages of an image processing pipeline often use image data in different orders. To improve cache performance, the compiler or other entity transforms data received from previous stages to accommodate the access patterns of subsequent stages.

### BACKGROUND

Image processing pipelines process images through a series of “stages.” These stages can have widely varying characteristics. Techniques for efficient processing through such stages are provided herein.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIG. 3 is a block diagram showing additional details of the graphics processing pipeline illustrated in FIG. 2;

FIG. 4 illustrates an image processing system according to an example;

FIG. 5 illustrates additional aspects of the image processing system of FIG. 4, according to an example;

FIG. 6 illustrates accesses made by the various stages of the image processing system of FIG. 4 according to an example;

FIGS. 7A-7B illustrate systems for reconfiguring data in memory to accommodate the different access modes; and

FIG. 8 is a flow diagram of a method for performing image processing, according to an example.

### DETAILED DESCRIPTION

Image processing pipelines are widely used for processing data from one format to another. Such pipelines can have a wide variety of effects. These pipelines are implemented as a series of stages, with earlier stages processing data and providing output information for use by subsequent stages.

Oftentimes, each pipeline stage is implemented independently. In other words, a programmer writes a program (sometimes called a “kernel” or a “filter kernel”), symbolically declaring the inputs, outputs, and intermediate resources (e.g., number of registers, amount of memory, or the like) used by such programs. If naively executed, such stages could result in a great deal of excess resource utilization where resources could be reused between stages. Further, it is possible that the data output by one stage could be accessible inefficiently by subsequent stages.

Thus, the present disclosure provides techniques for alleviating these issues. According to one such technique, an entity such as an offline or runtime compiler analyzes the code of each of the stages and makes adjustments to the code in order to more efficiently process the information. In one example, the compiler detects the order of processing of the stages and rearranges the data to match the order of processing. In an example, where a first stage processes image data in row-major order (e.g., following the order of elements of a row before proceeding to the next row) and a second stage processes image data in column-major order (following the order of elements of a column before proceeding to the next column), the adjustments cause the image data to be transposed as appropriate. In an example, for a stage that processes data in column-major order, the compiler reorganizes the data such that elements of columns are contiguous in memory. This causes temporally nearby accesses to be within the same cache line, which reduces unnecessary and duplicative cache traffic. In addition, the compiler causes buffers, registers, and/or caches to be reused across stages, where such buffers would be discarded after each stage in the naive implementation. Additional techniques and features are described below.

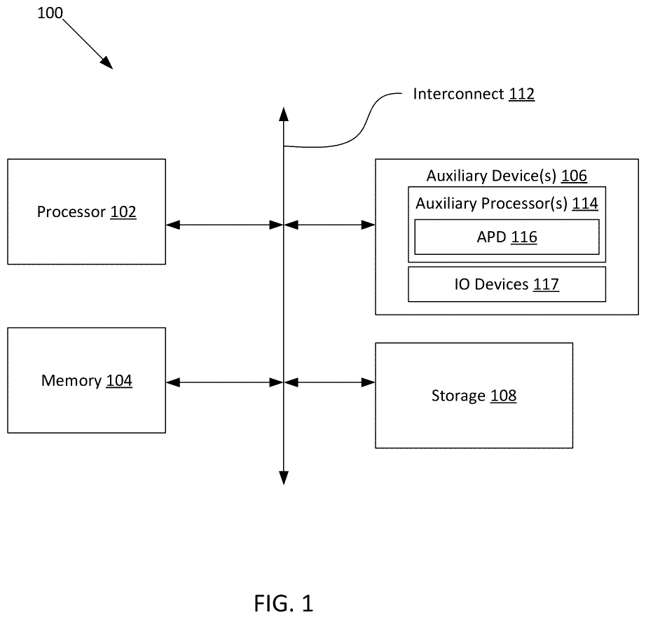

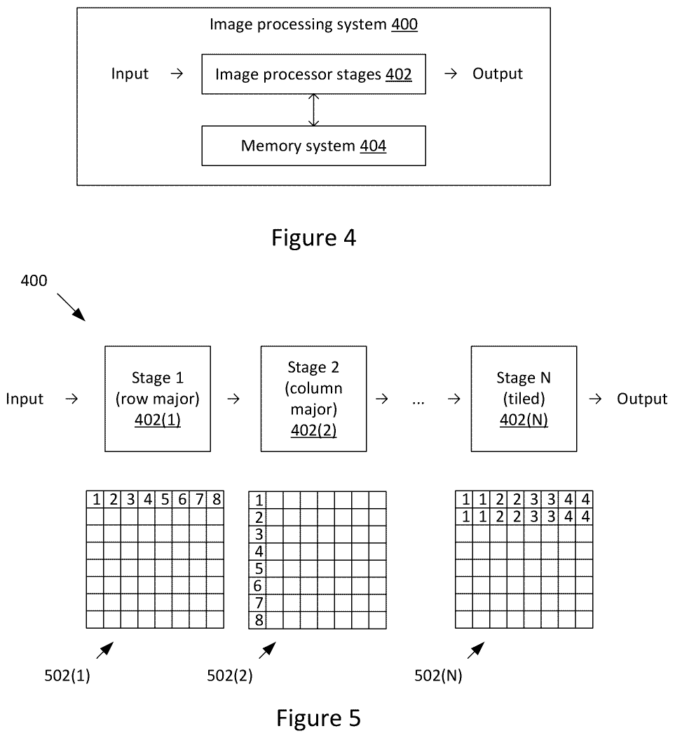

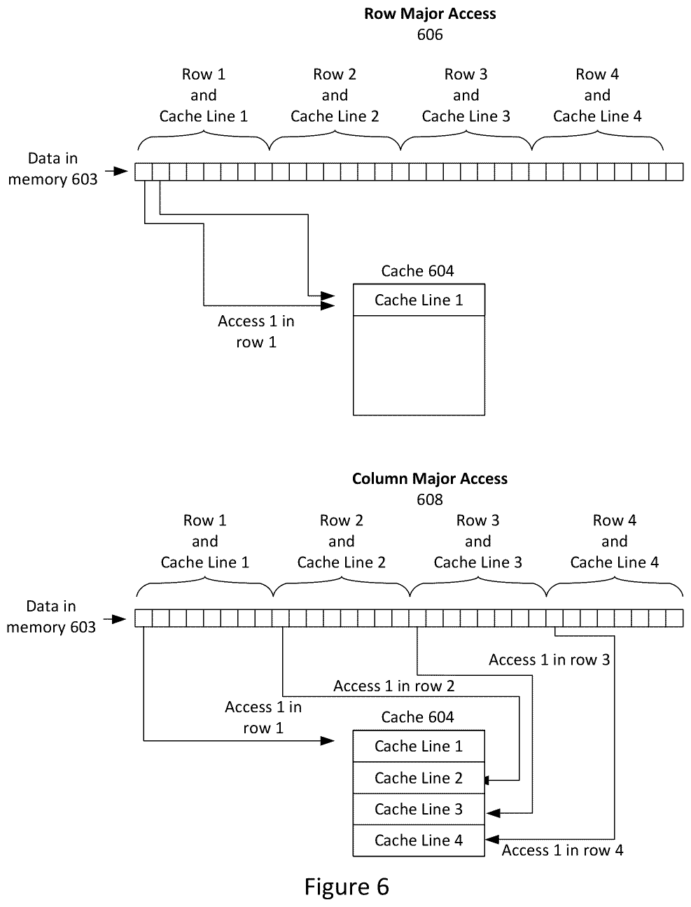

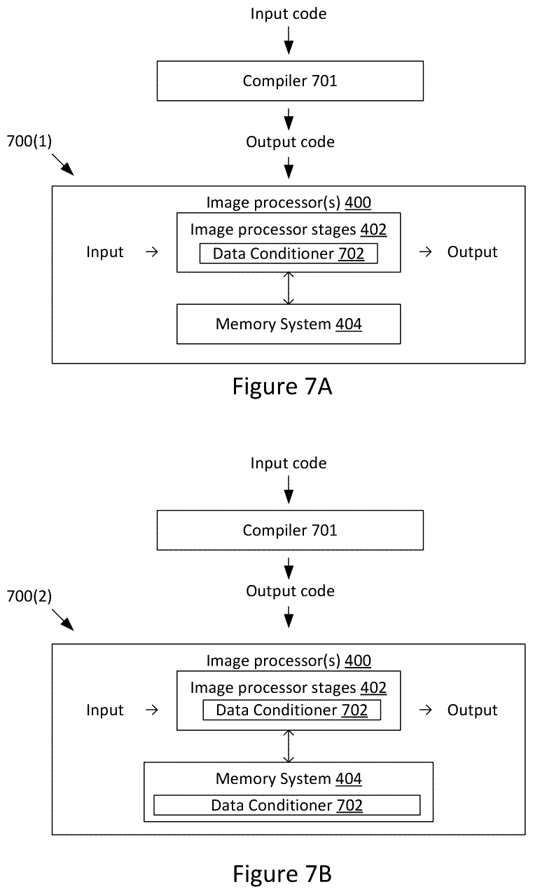

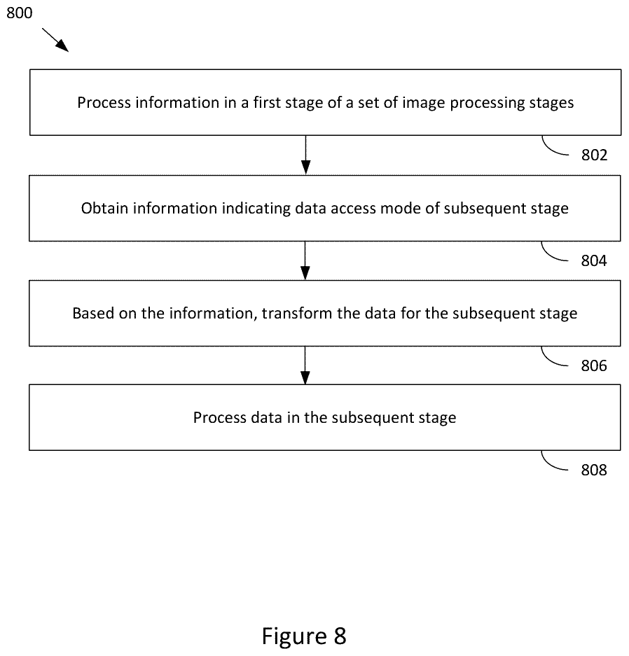

FIGS. 1-3 illustrate an example system in which the disclosed techniques can be performed. FIG. 4 illustrates an image processing system including a set of processor stages. FIGS. 5 and 6 illustrates example processing orders for various image processing stages. FIGS. 7A-7B illustrate an example image processing system with features for improved reuse and reorganization of data in an image processing pipeline. FIG. 8 illustrates a method for processing in an image processing pipeline.

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a parallel processing paradigm, such as a single-instruction-multiple-data (“SIMD”) paradigm or a single-instruction-multiple-threads (“SIMT”). Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a parallel processing paradigm may perform the functionality described herein. Alternatively, it is contemplated that computing systems that do not perform processing tasks in accordance with a parallel processing paradigm can also perform the functionality described herein.

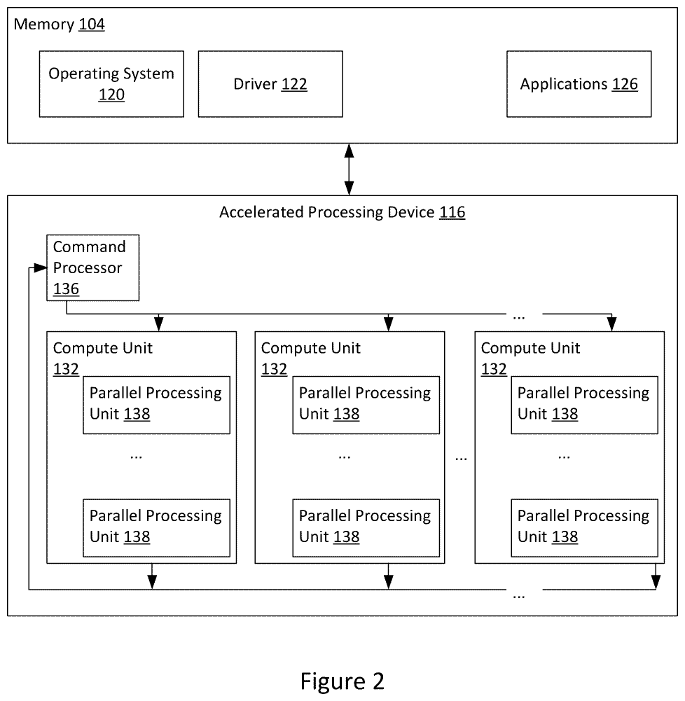

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen lanes, where each lane executes the same instruction at the same time as the other lanes in the parallel processing unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps. One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A scheduler 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

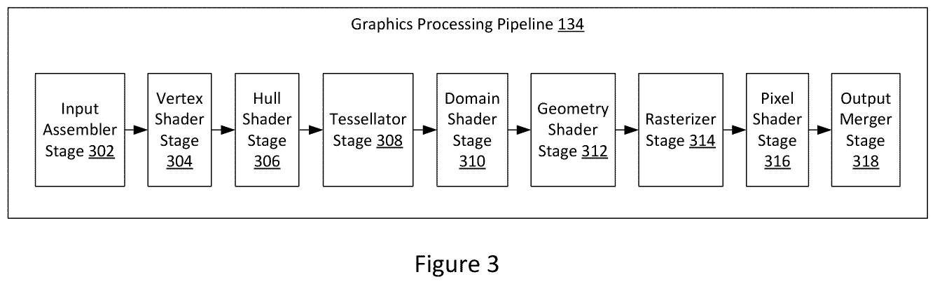

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

FIG. 4 illustrates an image processing system 400 according to an example. The present disclosure relates to improvements for processing through an image processing pipeline. Specifically, an image processing pipeline includes a number of different stages 402 that perform different functions for image processing. In an example, the image processing stages 402 accept input, and process the input through the stages to produce an output. In the course of performing these operations, the image processing stages 402 store information into a memory system 404. In some examples, this information includes intermediate information used in the course of performing the image processing (e.g., information produced by one stage 402 and consumed by another stage 402).

In some examples, the image processing system 400 includes one or more processors (e.g., the processor 102, the APD 116, and/or another processor) that implements one or more of the image processor stages 402. In some examples, one or more of the image processor stages is implemented by fixed function circuitry (such as fixed function image processing circuitry). In some examples, the memory system 404 includes one or more cache memories, and/or one or more non-cache memories.

FIG. 5 illustrates additional aspects of the image processing system 400, according to an example. As can be seen, the image processor stages 402 includes stage 1 402(1) through stage N 402(N) (i.e., N stages). Each stage 402 processes its input, received as input to the image processor stages 402 or from an earlier stage 402, and produces an output. In various examples, the input received by a particular stage 402 is an image that has elements arrayed in two dimensions (e.g., width and height). The stage 402 processes the input image to generate an output image for the next stage 402 or as output of the image processor stages 402.

FIG. 5 also illustrates memory access order for different stages 402. Each memory access order illustrates the order in which the operations of a particular stage 402 accesses data being processed (e.g., the input images). It should be understood that the specific orders illustrated are exemplary and it is not intended that the stages 402 of the image processing stages 402 necessarily access elements in the orders illustrated.

Each memory access order indicates the order in which the corresponding stage accesses elements of data being processed. More specifically, each stage accesses elements of an image in a particular order. Some such orders include row major, column major, or tiled. In row major order, the stage 402 processes elements in a row in sequence and then proceeds to the next row. In an example, stage 1 402(1) is in row major order and thus (referring to image 502(1)) processes element 1, then element 2, then element 3, and so on, up to element 8 and then moving to the next line and performing the same actions. In an example, stage 2 402(2) is in column major ordering, and thus (referring to image 502(2)), processes element 1, then 2, then 3, and so on, to element 8, and then to the next column, processing elements within a column before proceeding to the next column. In the tiled order shown as an example at stage N 402(N), access occurs in a tile-by-tile manner—first to tile 1 (which is a 2×2 tile, as an example), then to tile 2, and so on. Note that although the tiles are shown as not overlapping in the example of stage N 402(N), it is possible for tiles to overlap such that there is reuse of elements between tiles.

In summary, FIG. 5 illustrates that different stages 402 of the image processing system 400 can process elements of an input image in different orders. This aspect can result in inefficiencies related to cache access.

FIG. 6 illustrates accesses made by the various stages 402 of the image processing system 400 according to an example. Specifically, FIG. 6 illustrates a row major access mode 606 and a column major access mode 608. It should be understood that these are exemplary access modes and that others are possible. In each mode, a stage 402 of the image processing system 400 accesses data to process that data and generate an output. The layout of the data in memory 603 is illustrated. This layout is the typical layout for image processing, which is that elements (e.g., pixel data) for the images are sequentially laid out in each row and then one row is laid out after another. In other words, in memory, the elements of each row are contiguous in memory such that the left-most element is before the next right element, which is before the next right element, and so on until the end of the row. Then the next row is found in memory, and so on. As shown in FIG. 6, elements (the small squares) for each row for the data in memory 603 are contiguously laid out and the rows are laid out one after the other. In general, the sequence with which the image processing stages 402 access the data in memory 603 is dependent on the access mode (e.g., row major, column major, or others).

The layout of the data in memory 603 and the access mode used to access that data has a great impact on the performance of the data accesses. This is primarily because accesses to data that are not in the cache cause a cache miss. A cache miss results in the cache fetching the cache line that contains the requested data. A cache line is a set of data having contiguous addresses in memory. In the examples of FIG. 6, a cache line can store 8 image elements (e.g., 8 pixels). When a cache line is fetched into the cache, a much larger amount of data is fetched into the cache than the single element accessed. If the additional data in that line will be used soon, then this is an efficient means of operation. However, if the additional data in that line will not be used soon, then the cache line may age out of the cache (e.g., become evicted from the cache due to other cache lines being fetched into the cache). If this type of access occurs repeatedly, then the cache system is used very inefficiently—there would be a much higher degree of memory bandwidth consumption than would be necessary. This idea is described in greater detail below.

An image processing stage 402 that uses the row major access mode 606 accesses elements sequentially in a row and then, at the end of the row, proceeds to the next row. In FIG. 6, it can be seen that a first access accesses a first element (e.g., the left-most element) in a first row, which results in cache line 1 (including that first element) being read into the cache 604. Subsequent accesses in that row—to elements 2 through 8 of that row—read from the same cache line—cache line 1—which is already in the cache. As can be seen, this particular configuration does not result in a significant degree of inefficiency.

In the column major access 608, the image processing stage 402 accesses elements in a column in order. In other words, the image processing stage 402 accesses a first (e.g., top) element in a first column, then the next bottom element in that column, and so on. With the data in memory 603 laid out in the same manner as with the row major access mode 606, each subsequent access is to a different cache line. Thus, a first access results in cache line 1 being read into the cache 604, a subsequent access results in cache line 2 being read into the cache 604, and so on. In this example, it is assumed that row 1 is directly above row 2, which is directly above row 3, and so on, so that the first element of row 1 is directly above the first element of row 2, which is above the first element of row 3, and so on. As can be seen, this is an inefficient use of the cache.

FIGS. 7A-7B illustrate systems 700 for reconfiguring data in memory to accommodate the different access modes. In general, each system 700 includes a data conditioner 702 that transforms the data to allow for more efficient access than if the data remained static. In some examples, transforming the data means rearranging the data so that accesses to elements in particular access mode that would not be contiguously accessed without the transformation are contiguously accessed with the transformation. In other words, the transform for a particular access mode rearranges the data so that accessing according to that particular access mode occurs sequentially. In an example, row-major data is rearranged in column-major format. In other words, data for which elements of a row are arrayed contiguously in memory is rearranged such that instead, elements of a column are arrayed contiguously. Any other transform is possible. In general, the data conditioner 702 transforms the data from a format appropriate for one image processor stage 402 to a data format appropriate for another image processor stage 402 (e.g., the immediately subsequent image processing stage 402).

In some examples, the data conditioner 702 also reuses the data buffers used by the image processing stages 402 so that a smaller amount of memory is allocated for operation of the image processor 400. In an example, the data conditioner 702 causes the image processor stages 402 to alternate between one of two buffers (or a fixed number, greater than 2, of buffers). More specifically, without this operation, each image processor stage 402 would be free to allocate a buffer for either or both if the input or output to the stage 402. Such a buffer could be at any location, including memory not already used. In a pathological example, in the event that each stage 402 allocates its own separate buffer for input and output information, the image processor(s) 400 would be required to copy from the output of each stage 402 to the input of each other stage 402. In addition, the cache lines of the newly allocated buffers would not necessarily be resident in the caches of the memory system 404, meaning that subsequent stages 402 would require cache line fetches for new cache lines. By contrast, with reuse of the buffers, the cache lines would have a greater chance of remaining in the cache, since a smaller number of memory addresses would be used. Alternating between the two buffers means that one stage 402 writes to a buffer, which becomes the input buffer for the subsequent stage 402. That stage 402 in turn writes to the buffer used by the previous stage 402 as input. This second buffer now becomes the input buffer for the next stage, which writes to the other buffer, and so on, with each stage alternating which buffer is used as input and which as output.

In another example, the data conditioner 702 causes the registers used by one image processing stage 402 to be reused by subsequent image processing stages 402. More specifically, as with the memory buffers, image processor stages 402 declare and allocate their own sets of registers. Thus the set of all image processor stages 402 involved in processing an image utilizes a certain relatively large set of registers. In some examples, the data conditioner makes at least some of the registers used by one image processor stage 402 available to at least one subsequent image processor stage 402 assuming such registers are used by the subsequent at least one image processor stage 402. In an example, if a first stage 402 writes to a first register and the value in that register is used by a subsequent stage 402, then instead of allocating a new register for the subsequent stage 402 and writing the value from the old register memory and then writing that value to the newly allocated register, the data conditioner 702 causes the old register to be available to and used by the subsequent stage, with the desired value remaining in the register. In various examples, the data conditioner 702 performs this operation for any portion of registers of one stage in order to be used by the subsequent stage.

In summary, the data conditioner 702 causes the image processor stages 402 to more efficiently utilize resources such as cache memory and registers. Regarding cache memory, the data conditioner 702 causes input data for any given stage 402 to be organized in a way that is appropriate for the access mode of that stage 402. In some examples, the data conditioner 702 also causes resources such as registers and buffers to be reused between stages 402.

FIGS. 7A-7B illustrate different systems 700 that include data conditioners 702. In FIG. 7A, the role of the data conditioner 702 is performed by the image processor stages 402 themselves. More specifically, the image processor stages 402 perform one or more of the operations described above, including causing input and output buffers to be reused between stages 402, causing the data to be reconfigured, and/or causing registers to be reconfigured. A compiler 701 inserts this functionality into the image processor stages 402 based on initial input code. More specifically, input code is produced at an early stage such as by a human developer. A compiler 701 examines this input code and generates output code, which is executed in the image processor(s) 400 as part of the image processor stages 402. In some examples, the compiler 701 is part of a driver that controls operation of the image processor(s) 400 and examines input code provided (e.g., by an application or by the driver itself or a different driver). In some examples, the compiler 701 is part of the same computer system or device as the image processor 400 and operates at runtime. In other examples, the compiler 701 is an offline compiler that analyzes input code to generate the output code.

In some examples, the input code does not utilize the techniques described herein and the compiler 701 automatically generates the output code to utilize one or more of the techniques described herein. Because the image processor stages 402 are configured to perform the techniques described herein, the data conditioner 702 in this scenario is illustrated as being part of the image processor stages 402. In some examples, the input code for each stage 402 declares input and output buffers in a way that does not necessarily require those buffers to alternate locations in memory as described above. The compiler 701 compiles this code in a way that causes the stages 402 to reuse the buffers between stages 402 as described elsewhere herein. Similarly, in some examples, the input code simply declares registers and the compiler 701 recognizes registers that contain data that is used in different stages 402 as described elsewhere herein and causes the stages 402 to reuse the registers. In some examples, the input code includes hints about the access mode (e.g., row major or column major) or the compiler 701 analyzes the input code to determine the access mode and the compiler 701 inserts instructions into the output code to move data between stages to accommodate the access mode.

In an example, where a first stage 402 has a row major access mode, the instructions to move data causes the data for the output to be stored in a way that data in columns are laid out contiguously in memory (e.g., a first (e.g., left-most) element of a first row is stored in memory, then a first element of a second row is stored in the immediately subsequent memory location, then the first element of a third row is stored in the immediately subsequent memory location, and so on). In general, the instructions to accommodate the access mode of a subsequent stage cause an earlier stage 402 (or intra-stage logic) to store data in a layout that is appropriate for the access mode of the subsequent stage 402. “Appropriate for” means, in some examples, that the order of the elements in memory matches the access order of the elements by the stages 402.

In an alternative implementation, illustrated in FIG. 7B, the memory system 404 includes at least a portion of the data conditioner 702. More specifically, in some examples, at least some of the instructions inserted into the image processor stages 402 for conditioning the data include instructions that request hardware assistance for such conditioning. In some examples, this hardware assistance includes operations for moving data to accommodate the access mode of a particular image processing stage 402. In an example, one stage writes data according to its access mode. The compiler 701 inserts instructions for that stage 402 to request the hardware data conditioner 702 to reconfigure (e.g., transpose) the data to be appropriate for the memory access mode of the immediately subsequent stage. Then, the data conditioner 702, which is part of the memory system 404, moves that data as appropriate for that subsequent stage. It should be noted that these hardware operations, once requested, are performed without the intervention of the image processor stages 402. In other words, software of the image processor stage 402 requests the hardware perform these operations and the hardware performs the operations.

In another alternative implementation, the memory system 404 written to by the stages 402 is special purpose memory that is used by the different memory stages 402 without copying. In other words, instead of writing to general purpose memory, the stages 402 write output and read from input that is stored in a special purpose memory that has the ability to either output data stored within at a given format (e.g., as appropriate for a particular access mode) or the ability to transpose data stored within to be appropriate for a particular access mode. In an example, one stage 402 stores data into the special purpose memory and a subsequent stage 402, having a different access mode, reads the data from the special purpose memory. The special purpose memory rearranges the data to be appropriate for the access mode of the subsequent stage 402.

In general, the data conditioner 702 is one or both of software or hardware, configured to perform the operations described herein. The software can be executed as part of the stages 402, as part of an application or driver that is included within the same computer system as the stages 402, or as part of software external to such a system. In some examples, the data conditioner 702 includes or is circuitry (e.g., digital circuitry) that is configured to perform at least some of the functionality described herein.

In some examples, the input code of the stages 402 specifies elements of the image being processed using an “abstracted pixel specifier.” In other words, rather than attempting to access the pixels by memory address, the stages 402 specify elements of the images by coordinate (e.g., x and y coordinates). This allows the data conditioner 702 to perform the appropriate operations (e.g., accessing the correct data element) as needed.

As stated above, there are a variety of memory access modes. Some examples modes include row major, column major, and tiled (described above). Another example mode includes z-curves or hilbert-curves (e.g., accesses are made in an order according to a z-curve or hilbert-curve, which traverses in a zig-zag pattern through an image). In some additional examples, a tiled ordering is used, with tiles that overlap in the image. In some such examples, the same pixels are duplicated in different tiles. In some such examples, such tiles are laid out contiguously in memory such that elements of such tiles are duplicated in memory. In some examples, the data conditioner 702 adds padding elements do data in order to prevent cache line straddling. In some examples, the data conditioner 702 performs other operations to the data when moved for access by a subsequent stage 402, such as channel swizzling (where channels include values for color components, such as red, blue, and green, and swizzling includes rearranging these values), quantizing the data (e.g., reducing the precision of the representation, such as by reducing the number of bits used).

FIG. 8 is a flow diagram of a method 800 for performing image processing, according to an example. Although described with respect to the system of FIGS. 1-7B, those of skill in the art will understand that any system configured to perform the steps of the method 800 in any technically feasible order falls within the scope of the present disclosure.

At step 802, a first stage 402 of a set of processing stages 402 processes information. Each stage 402 of the set of processing stages 402 performs a particular set of operations on input data to generate output data. A stage 402 consumes as input data from a prior stage or from the input to the set of processing stages 402 as a whole. In various examples, the processing stage 402 is implemented as software executing on a processor such as the processor 102, the APD 116, or a different processor. In some examples, these processors are launched as kernels and request allocation of resources such as memory for the input and output and registers to be used as a scratch space during processing. In some examples, where it is stated that a stage 402 performs an action, this should be understood to mean that the processor executes the particular code or instructions to perform the operations. In some examples, the processor is not a general purpose programmable processor like the processor 102 or APD 116 but is instead special purpose hardware (e.g., digital circuitry) that performs at least some of the described operations in an accelerated manner (as compared with software executing on a general purpose processor).

At step 804, a data conditioner 702 obtains information indicating the data access mode of a subsequent stage 402. In some examples, each stage 402 has an access mode that describes the order in which the stage 402 accesses elements being processed. More specifically, any stage 402 (in some examples, each stage 402) accesses elements of the input to that stage 402 in a particular order. Example orders have been described herein and include row major order, column major order, tiled (with or without overlap), Z-order or Hilbert-order, or other orders. In some examples, each stage 402 includes an annotation or other information that indicates the access order of that stage 402. In some examples, this information is included in the code for the stage 402, in metadata for the stage 402, or in compiled instructions for the stage 402. In some examples, the information is not explicitly included but is apparent from the code of the stage 402 itself. In some examples, the access order is easily obtained through code analysis, for example, by observing the order in which the stage 402 accesses data. In an example, the code for each stage 402 includes a set of accesses made to pixels, specified by pixel coordinate rather than by address. In such examples, the data conditioner 702 can simply observe the order of such pixel accesses. In other examples, each stage 402 specifies accesses by address and the data conditioner 702 analyzes such addresses to determine the intended order. In any case, the data conditioner 702 is able to determine the access mode of the subsequent stage 402 in order to perform further actions.

In some examples, the data conditioner 702 is a compiler (e.g., compiler 701) that accepts uncompiled or compiled code. This compiler 701 can be a just-in-time compiler that executes on the same system as the stages 402 or can be a traditional compiler that analyzes the stages 402 statically. Where the compiler 701 is a just-in-time compiler, the compiler is able to perform analysis on sequences of image processor stages 402 that are constructed at runtime.

At step 806, the data conditioner 702 transforms data for the subsequent stage 402 based on the information obtained at step 804. In some examples, the data conditioner 702 is part of one or more of the stages 402 themselves. More specifically, in such examples, one or more such stages 402 includes instructions that cause data generated by the first stage 402 to be reconfigured for the subsequent stage 402. In some examples, these instructions simply cause the first stage 402 to write its output into a buffer in an order appropriate for the access mode of the subsequent stage 402. In other examples, these instructions cause the first stage 402 to move its output data around to a format that is appropriate for the access mode of the subsequent stage 402. Although described as being performed by the first stage 402, in some examples, some or all of the operations are performed by the subsequent stage 402. In some examples, the operations for transforming the data are hardware-accelerated, meaning that the memory system 404, itself, is able to transpose data from one format (e.g., row-major) to another (e.g., column-major) at the request of a stage 402 (where “transpose” means converting data from being appropriate for one memory access mode to being appropriate for another memory access mode). In other words, rather than specifying and performing each individual memory access operation, a stage 402 can simply execute an instruction to perform a transpose, and then the memory system 404 performs the entire transpose, without requiring additional intervention from the stage 402. In yet other examples, the data written as output from one stage 402 is written to a special purpose memory that has the capability to transpose the data for the subsequent stage 402. In various examples, the first stage 402 configures this special purpose memory with information about the memory access mode of the subsequent stage 402 and writes its output to that memory. Then, when the subsequent stage 402 accesses the data in the memory, it is accessed according to the memory access mode appropriate for that subsequent stage 402.

At step 808, the subsequent stage 402 processes the data according to its instructions. As described elsewhere herein, this stage 402 can perform any operation such as any image processing operation. In general, each stage 402 accesses input data, performs processing on the input data, and outputs generated output data.

In some examples, in addition to the above, in various examples, the data conditioner 702 performs any of the following operations: causing buffers to be reused between stages (with, e.g., the buffers alternating between input and output for subsequent stages as described elsewhere herein), causing local memories, caches, and/or registers (such as APD 116 local data share) to remain persistent between stages 402 (in other words, in some instances, “normal” operation is to prevent any resource used by one stage 402 be reused by a subsequent stage 402; in the above operation, the data conditioner 702 causes one or more such items used in one stage 402 to remain available in a subsequent stage 402). In some examples, this prevents the necessity for reallocation and copying of data in subsequent stages 402.

When it is stated that “a stage 402 performs an operation” or similar language, this should be understood to mean that the hardware that implements this stage 402 performs such action. In examples where the stage 402 is implemented entirely as software, this should be interpreted as meaning that a processor (e.g., digital circuitry or some other form of programmable processor) that executes the software performs the operations of the stage 402. In some examples, part of or all of a stage 402 is implemented as hardware (e.g., a dedicated hardware accelerator such as dedicated digital circuitry), in which case, the statement above should be interpreted as meaning that this hardware performs these operations. In various examples, a single processor (e.g., the processor 102 or APD 116) performs the operations for one or more of the stages 402. In an example, such a processor is programmed to perform the operations of each of the stages 402 of a set of stages.

It should be understood that many variations are possible based on the disclosure herein. Although features and elements are described above in particular combinations, each feature or element can be used alone without the other features and elements or in various combinations with or without other features and elements.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, the scheduler 136, compute units 132, SIMD units 138, input assembler stage 302, vertex shader stage 304, hull shader stage 306, tessellator stage 308, domain shader stage 310, geometry shader stage 312, rasterizer stage 314, pixel shader stage 316, output merger stage 318, image processing system 400, processor stages 402, memory system 404, or data conditioner 702 may be implemented as “hardware,” “software” or any technically feasible combination thereof; where “hardware” includes, without limitation, a general purpose computer, a processor, a processor core, a programmable logic device, a field programmable gate array, a digital circuit, an analog circuit, a fixed-function circuit; and where “software,” includes, without limitation, a program, an app, firmware, an application, a device driver, or any other set of executable instructions, stored in a non-transitory computer readable medium or in another medium, executable by a general purpose computer, a processor, or a processor core, or as any technically feasible combination of hardware or software. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for processing images, the method comprising:
first processing of first input data at a first stage of a set of stages, the first processing being performed with a first data access mode to generate first output data;
transforming the first output data to a second format associated with a second data access mode to generate second input data for a second stage of the set of stages; and
processing the second input data at the second stage according to the second data access mode.

2. The method of claim 1, wherein the first data access mode includes one of a column-major processing order, a row-major processing order, a tiled order, or a zigzag processing order.

3. The method of claim 1, further comprising automatically detecting the first data access mode of the first stage and the second data access mode of the second stage.

4. The method of claim 3, wherein the automatically detecting is performed by a compiler analyzing patterns of accesses of code of the first stage and code of the second stage.

5. The method of claim 1, further comprising maintaining one or more of registers, cache, or memory between the first stage and the second stage.

6. The method of claim 1, wherein the transforming is performed by instructions of the first stage, the second stage, or both the first stage and the second stage.

7. The method of claim 1, wherein the transforming is performed as a hardware accelerated operation.

8. The method of claim 1, wherein the transforming comprises copying the first input data from a first location to a second location in a way that adjusts positions of elements of the first input data to match an access pattern of the second access mode.

9. The method of claim 1, wherein the transforming comprises copying edge pixels of a tile format to generate the second input data.

10. A system for processing images, the system comprising:
a memory configured to store first input data; and
a processor configured to:
perform first processing of the first input data at a first stage of a set of stages, the first processing being performed with a first data access mode to generate first output data;
transforming the first output data to a second format associated with a second data access mode to generate second input data for a second stage of the set of stages; and
processing the second input data at the second stage according to the second data access mode.

11. The system of claim 10, wherein the first data access mode includes one of a column-major processing order, a row-major processing order, a tiled order, or a zigzag processing order.

12. The system of claim 10, wherein the processor is further configured to automatically detect the first data access mode of the first stage and the second data access mode of the second stage.

13. The system of claim 12, wherein the automatically detecting is performed by a compiler analyzing patterns of accesses of code of the first stage and code of the second stage.

14. The system of claim 10, wherein the processor is further configured to maintain one or more of registers, cache, or memory between the first stage and the second stage.

15. The system of claim 10, wherein the transforming is performed by instructions of the first stage, the second stage, or both the first stage and the second stage.

16. The system of claim 10, wherein the transforming is performed as a hardware accelerated operation.

17. The system of claim 10, wherein the transforming comprises copying the first input data from a first location to a second location in a way that adjusts positions of elements of the first input data to match an access pattern of the second access mode.

18. The system of claim 10, wherein the transforming comprises copying edge pixels of a tile format to generate the second input data.

19. A non-transitory computer-readable medium storing instructions that, when executed by a processor, cause the processor to perform operations comprising:
first processing of first input data at a first stage of a set of stages, the first processing being performed with a first data access mode to generate first output data;
transforming the first output data to a second format associated with a second data access mode to generate second input data for a second stage of the set of stages; and
processing the second input data at the second stage according to the second data access mode.

20. The non-transitory computer-readable medium of claim 19, wherein the first data access mode includes one of a column-major processing order, a row-major processing order, a tiled order, or a zigzag processing order.
